(19) United States
(12) Patent Application Publication
(10) Pub. No.: US 2010/0061229 A1
(43) Pub. Date: Mar. 11, 2010

(54) FAST RING REDUNDANCY OF A NETWORK

(76) Inventors: Werner Maisch, Neuffen (DE); Dirk Mohl, Esslingen (DE); Wolfgang Schmid, Kirchheim unter Teck (DE); Andreas Stiegler, Kirchentellinsfurt (DE)

Correspondence Address: K.F. ROSS P.C., 5683 RIVERDALE AVENUE, SUITE 203 BOX 900, BRONX, NY, 10471-0900, US

(21) Appl. No.: 12/593,936

(22) PCT Filed: Jul. 4, 2008
(86) PCT No.: PCT/EP08/05485

§ 371 Date: Sep. 30, 2009

(30) Foreign Application Priority Data
Jul. 5, 2007 (DE) 102007031443.6

(51) Int. Cl. G06F 11/00

(52) U.S. Cl. 370/222

(57) ABSTRACT

The invention relates to a method for operating a network as well as a network comprising at least one switch (400) and network infrastructure devices that are connected to said at least one switch (400) which is controlled by a control unit (700). According to the invention, a redundant unit (550) that is connected between the switch (400) and the control unit (700) analyzes the data stream between the switch (400) and the control unit (700), and data is inserted into and/or is removed from the data stream in accordance with the result of the analysis.

The invention relates to a network and a method of operating a network according to the respective preambles of the independent claims.

The invention particularly relates to Ethernet switches in networks. The invention especially relates to switches in networks in specific environments. The invention, however, does not need to be limited to use in switches, but is preferably applicable in this regard. For this reason, the application of the invention in switches will be addressed below, although the invention may generally be applied in connection with the above-described electronic devices that are connected to a network with at least two network accesses.

### PRESENT SITUATION (PRIOR ART)

If a network is composed of switches, it is frequently required in the event of a line interruption that automatic switching take place to redundant connections that up to this point were inactive. This way, the interruption of data transmission is limited to a minimum.

To this end, international standard IEEE 802.1D describes the Spanning Tree Protocol and in its more recent issue the faster version, referred to as the Rapid Spanning Tree Protocol (RSTP). The idea is for a network to be interconnected with switches in any order. The rule for the Ethernet is that only one active connection may exist between two subscribers at any one time. Using its algorithm, the protocol breaks down the network into a tree structure and disables all duplicate connections. The connections are then activated should the need arise, namely if the original connection fails. The rapid spanning tree protocol allows for reliable switching, but has limitations in terms of its network diameter and its reliable switching speed to a redundant connection. This means that it cannot always be guaranteed that the switching can take place very rapidly or during a precisely predetermined time. Thus, in terms of its switching time, the protocol is not deterministic. The fact that the topology can be arbitrary, and thus the clarity and predictability cannot always be easily derived, is further disadvantageous for the application of the protocol.

For this reason, a method of ring redundancy was specified in WO 1999/046908 [U.S. Pat. No. 6,430,151]. This method is distinguished by its simple topography in the form of a ring and a deterministic switching time with a maximum of 500 ms (milliseconds). This method has prevailed in automation technology and is currently being standardized in the IEC work group IEC 62439. This allows for a switching time of up to no more than 200 ms.

### Problem:

The requirements of networks in automation have further increased. A guaranteed maximum down time of 500 or 200 ms is no longer sufficient in many applications. The field of safety/work safety is mentioned in this connection as a current example. Equipment in this area is increasingly built on the basis of communicating via Ethernet. In this connection the network is regarded by these applications as transparent for the safety protocol. A network failure, however, is recognized by the security-sensitive application and leads to an immediate shutdown of equipment. The requirement is to make the network failure so brief that it is not regarded as relevant for the security-sensitive application. Due to current applications the requirement came about that failures must be guaranteed to be below than 20 ms.

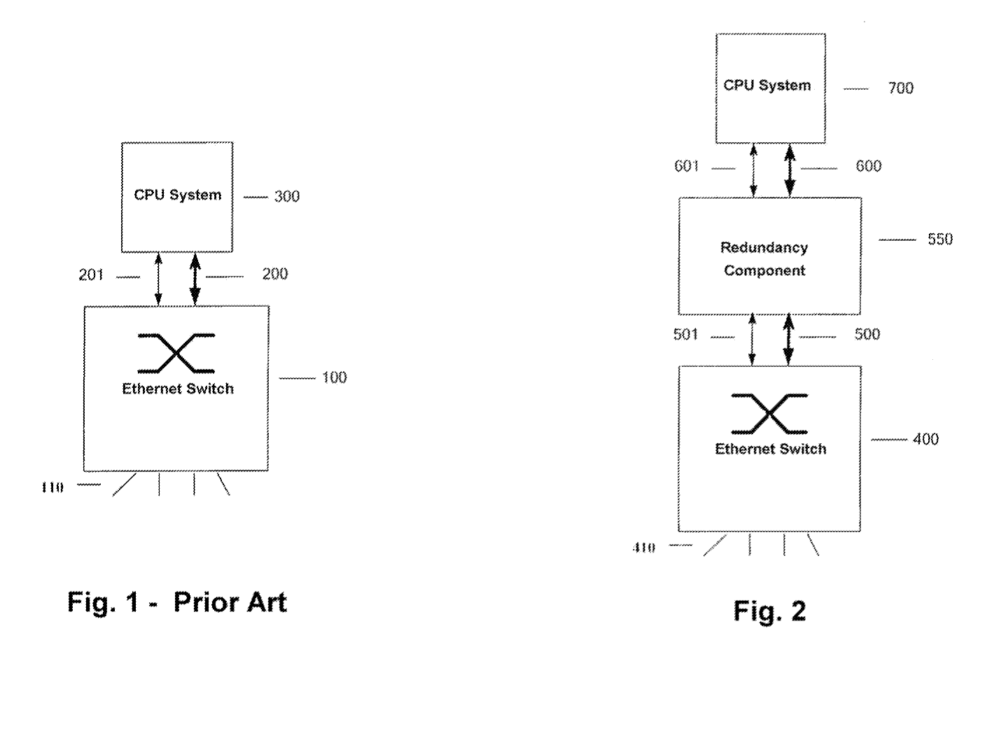

This requirement can no longer be met with conventional, known systems. Currently existing solutions are comprised of a CPU system, on which, in addition to many other time-consuming functions, the protocol is executed, and a switching chip, which is responsible for switching and which is also controlled via the CPU system (see the known system in FIG. 1 in this regard).

Thus far, the following technical approaches are is available to achieve the shortest possible as well as guaranteed switching time to solve this problem.
1. The CPU system is optimized accordingly so as to make a maximum of system resources available to process the redundancy protocol. This way, the response time can be reduced, but only in a very limited way due to firmly preset capacities.
2. The complete redundancy function is integrated into the switching chip. Currently, however, no usable solutions are available for this purpose. There are no commercial switching chips that provide the relevant functions. Furthermore, optimizing the CPU system exclusively in favor of the redundancy function does not make sense, since the costs for the system are no longer in line with the market if the system's performance is increased accordingly.

### Solution:

The solution is a system that is optimized for fast processing of the redundancy protocol. The basic function of the redundancy protocol is to be based on the functionality mentioned in patent WO 1999/046908 [U.S. Pat. No. 6,430,151].

The invention provides for a redundancy unit to be connected between the controller and at least the one switch. The advantage must be seen in that both the controller and the switch can carry out their own tasks and are freed from performing tasks that concern the redundancy of the network in the event of a failure. Particularly advantageously, this makes it possible to is reduce the response time significantly in the event of a failure and thus accelerate the response time to such a failure.

The idea is a structure that is basically identical with the current system and that attaches to standard components. Such structure however is added at a very specific location by a special component for the acceleration of the redundancy protocol.

The characteristic feature of this solution is that this component is installed in the two connections between the CPU system and the switch. Ethernet data travels via one of these connections and configuration and diagnosis data of the switch component on the other. Usually, the Ethernet data are transmitted via a MII, RMII, SMII, GMII or SGMII or a manufacturer-specific interface. The configuration communication with the chip takes place via a parallel or serial interface, e.g. SPI or MDIO.

In a further embodiment of the invention the redundancy unit comprises an input unit and a storage unit. The advantage is that data and programs (software) for the network's redundancy tasks can be input into the redundancy unit independent of the controller or independent of the switch. This means that modifications concerning the network's redundancy task can be executed independent of the operation of the controller or independent of the operation of the switch or other components of the network.

Alternatively, or additionally, a further embodiment of the invention provides for the redundancy unit to comprise at least one slot for a module for the purpose of adding functions. Instead of, or in addition to, the input unit it is possible to add functions, for example, to be able to modify, preferably expand, the scope of functions or the software of the redundancy unit.

In a further embodiment of the invention the controller is connected to the redundancy unit via an Ethernet interface and via a configuration interface. It is further alternatively or additionally provided that the redundancy unit is connected to the switch via an Ethernet interface and via a configuration interface. The advantage is that the data exchange within the network and its participating network infrastructure devices can take place via an Ethernet interface, whereas configuration data can be exchanged via the other interface.

A further embodiment of the invention provides that the redundancy unit is designed as ASIC or FPGA. The advantage of the embodiment as ASIC (Application Specific Integrated Circuit) is that the necessary data, parameters, and the like for operating the redundancy unit can be combined in this application-specific integrated circuit dependent on the tasks of the network and in consideration of the requirements of the network's operator. This increases the individuality of the redundancy unit, which fulfills the requirements of the network. An alternative embodiment provides for the redundancy unit to be designed as FPGA (Filed Programmable Gate Array). The FPGA contains programmable logic components and programmable interconnections with controllable switches between these components, with the entire system produced as a field or as a matrix. The components may map basic logic is functions and also be combined or linked to more complex logic such as decoders, encoders or mathematical functions. The advantage of FPGA must be seen in that it is programmed by the user post production, who inserts this component in his circuit. The term programming in this context, however, must be understood differently than during the creation of software for a processor. In a FPGA circuit structures are created by means of hardware description languages or in the form of circuit diagrams and these data are subsequently transmitted for the purpose of being configured in the component. This causes specific switching positions to be activated or deactivated in the FPGA, which then results in a specific, implemented, digital circuit. Since the function of the FPGA is exclusively determined by the configuration, the same component may be used for many different circuits and applications. Thus, the advantage is that the component may be produced in great quantities, which makes it very cost-effective compared to the ASIC, for example with prototypes and especially with small series.

In a further embodiment of the invention the redundancy unit is connected between the physical interface (PHY) of the controller and its Medium Access Control (MAC).

According to the invention a method is further provided for operating a network, with a redundancy unit connected between the switch and the controller analyzing the data stream between the switch and the controller, and with data inserted into the data stream and/or data removed from the data stream depending on the result of the analysis.

A further embodiment of the invention provides for the redundancy unit to transmit and/or receive test data, particularly test data packets, independently at a presettable data rate.

A further embodiment of the invention provides that the test data are network ring data or call data used for testing whether or not the network ring functions, and whether or not a link has been established between corresponding network infrastructure devices. In this connection, a topology of the network is configured such that network infrastructure devices such as switches, hubs, routers, PC sensors, actuators and the like exist in a ring network according to their function.

The configuration of such a system (part of a network) is illustrated in FIG. 2.

The redundancy unit may for example be realized in the form of a FPGA, but may also be embodied as an ASIC. The distinctive feature when realizing the redundancy unit as a FPGA is that the functionality may be imported into the FPGA even during operation, and thus it also possible to update the logic function of the FPGA via software.

Part of the invention is that the redundancy unit can analyze and remove Ethernet packets from the data stream between the switch chip and the CPU independently, as well as insert packets into the data stream independently. The redundancy unit may further independently exchange configuration and diagnosis data with the switch core.

A further part of the invention is that the function is inserted into the interface between MAC and PHY and is completely transparent for the rest of the system except for the redundancy function.

As basic functions to accelerate the redundancy, the redundancy component provides the following functioning blocks:
Independent transmission and reception of test packets at a selectable data rate,
Independent communication with the switch chip and, in this connection, the option of triggering the following functions: deleting address tables, switching the affected port in blocking, switching the affected port in forwarding,
Controlling access right (CPU or redundancy component) to the communication interface to the switch chip.

Furthermore, essential functions of the redundancy protocol are processed in the redundancy component.

Two conditions necessary for redundancy control can be checked by means of the test packets. Functioning of the ring can be tested by means of the ring test packets. The link test packets can test whether or not the link between two devices works. The link test packets are thus necessary since it turned out that the method of using the link status reported by the chip to determine whether or not a link has been established between two ports is not reliable and especially not quick enough.

Since the test packets can be generated by the redundancy unit, the latter can be generated at such a high rate that a link failure can be detected in a sufficiently brief time, just like the establishment of a link.

The redundancy unit's direct communication with the switch chip without detouring via the CPU system represents an additional advantage of this solution. Necessary switching processes resulting from reception of monitoring packets can be handled extremely fast.

By means of this solution it is possible to accelerate the desired response times to an error in the network to below 20 ms by separating functions that are not critical in terms of time and are resolved by software, and time-critical functions resolved by hardware.

Description of FIG. 1:

FIG. 1 shows a prior-art Ethernet switch system with management functionality.

It consists of a CPU system 300 that comprises an Ethernet interface 200 and is directly linked to an Ethernet switch 100 via an Ethernet port. The Ethernet switch transmits Ethernet data packets between external Ethernet ports 110 and the CPU system. The Ethernet switch 100 is further linked to the CPU system 300 via a configuration interface 201 for transmission thereto of control and status information.

Description of FIG. 2:

FIG. 2 shows the expansion of an Ethernet switch system with management functionality. The expansion is comprised of a redundancy component (FPGA, ASIC or a communication processor) 550 that is connected between a CPU system 700 and an Ethernet switch 400. Here the Ethernet data flows via Ethernet interfaces 600 and 500 to the Ethernet switch 400 and thence to external Ethernet ports 410. Control and status information moves through configuration interfaces 601 and 501. The redundancy component 550 makes sure that no access conflicts between the CPU and the redundancy function or data losses occur.

In summary, the invention is distinguished by the following design or through the following mode of operation:

An ethernet network component with at least two network connections characterized in that the component comprises a specific redundancy component between the CPU system and the switch, in particular the switch core, which holds the redundancy protocol in hardware.

The redundancy component is connected to the data communication between the CPU system and the switch core and can independently complete or filter out data packets.

The redundancy component is connected to the configuration communication between the CPU system and the switch core and can independently send configuration commands to the switch core and read out necessary configuration data.

Data communication between the CPU system and the switch core is controlled by traffic limitation such that sufficient bandwidth is always available for the redundancy component to supply data packets on its own.

A special handshake is used for the configuration communication between the CPU system and the switch system, which guarantees that the redundancy component receives the necessary is priority over CPU accesses.

In addition, the redundancy component is distinguished in that it makes retrofitting of additional functions for the system possible, which the prior-art switch hardware does not provide.

The redundancy component is distinguished in that it can be retrofitted for any data limitation into the CPU system.

The redundancy component is distinguished in that specific packets can be forwarded without overloading the CPU system.

1. In a network comprising at least one switch with an interface to network infrastructure devices of the network, with a controller allocated to at least the one switch, the controller being connected to the switch for data exchange the improvement wherein a redundancy unit is connected between the controller and the switch.

2. The network in accordance with claim 1 wherein the redundancy unit comprises an input unit and a storage unit.

3. The network in accordance with claim 1 wherein the redundancy unit comprises at least one slot for a module for the purpose of adding functions to the redundancy unit.

4. The network in accordance with claim 1 wherein the controller is connected to the redundancy unit via an Ethernet interface and a configuration interface.

5. The network in accordance with claim 1 wherein the redundancy unit is connected to the switch via an Ethernet interface and via a configuration interface.

6. The network in accordance with claim 1 wherein the redundancy unit is designed as an application-specific integrated circuit or as a filed programmable gate array.

7. The network in accordance with claim 1 wherein the redundancy unit is connected between the physical interface of the controller and its Media Access Control.

8. A method of operating a network comprising at least one switch and network infrastructure devices that are connected to the switch, with the switch controlled by a controller wherein a redundancy unit connected between the switch and the controller analyzes the data stream between the switch and the controller, and data is inserted into the data stream or data is removed from the data stream depending on the result of the analysis.

9. The method in accordance with claim 8 wherein the redundancy unit can independently transmit or receive test data packets at a presettable data rate.

10. The method in accordance with claim 9 wherein the test data are network ring data or call data used for testing whether or not the network ring functions, and whether or not a link has been established between corresponding network infrastructure devices.
